(19) United States
(12) Patent Application Publication
(10) Pub. No.: US 2010/0059303 A1
(43) Pub. Date: Mar. 11, 2010

(54) Self Moving Cart for Invalids, and Method for Managing Said Cart in Business Centres or Other Specific Areas

(75) Inventor: Marco Paolacci, Laterina (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MP S.r.L., San Casciano Val di Pesa (FI) (IT)

(21) Appl. No.: 12/516,774

(22) PCT Filed: Sep. 26, 2007
(86) PCT No.: PCT/IT2007/000671

§ 371 Date: May 28, 2009

(30) Foreign Application Priority Data
Dec. 1, 2006 (IT) PI2006A000139
Dec. 1, 2006 (IT) PI2006A000140

(51) Int. Cl. B60L 11/18; B60K 17/30; B60K 1/02; B60R 25/04; B60K 17/34; B60P 1/64; B60R 99/00; B62D 63/02

(52) U.S. Cl. 180/253; 180/65.1; 180/287

(57) ABSTRACT

The present invention concerns a self moving transport mean for partially disabled people and a method for using said transport mean in shopping centres or other specific public areas. The transport mean houses seats or wheel-chairs and gives the user the chance to access all the services of said areas thanks to proper drive systems, safety devices, and a simple and safe lifting device of a flat surface supporting the wheel-chair or the seat. The method of the invention provides a box for housing and recharging the transport means and the exchange of data between them and a central processing unit of the area apt to let the completely enjoying the services of the area and the mobility features of the transport means.

### TECHNICAL FIELD

The present invention refers to a method for managing transport means for invalids in specific areas, in particular business centres.

The invention also refers to transport mean for invalids or partially disabled people.

### STATE OF THE ART

As known, partially disabled people, often confined to move on a wheel-chair, come across difficulties at accessing many kind of buildings due to the presence, still at present, of architectural barriers: staircases, narrow passages, abrupt ropes and many others.

Great efforts have been performed, mainly in big public buildings, to remove said architectural barriers and more and more attention is paid to the matter in designing new buildings. Yet, in spite such efforts to improve the quality of life of partially disabled people, these lasts are still unable to use lots of services and facilities of the above buildings.

You can consider, for instance, that in supermarkets or in shopping centres, or even in libraries or bookshops, there are shelves with products placed so high that they cannot be reached by a partially disabled person, even more if the person is confined to move on a specific wheel-chair.

In different, large sized, areas or buildings, such as hospitals, courts of justice, campus, people have to deal with the matter of having to find specific places or offices without getting lost or running long distances.

Partially disabled people, according to their handicap, use wheel-chairs that can be provided with specific accessories or can assume specific configurations or have specific features but that, unfortunately, cannot fix the above matters, deriving from the need to use them in the above cited buildings and areas.

Self moving carts for invalids or for transporting manually driven wheel-chairs have been proposed, in the past, said carts being substantially made of a platform on wheels where the wheel-chair is mounted and of the platform's driving systems.

Said carts still have very limited functions and they do not provide devices apt to allow a safe and reliable use in specific areas. Anyway, whatever the transport mean for partially disabled people used in said areas is, there is to face the matter of its proper and cost-effective management.

The matter of a proper management become of primary relevance when said transport means is not directly owned by the invalid but rather it is a permanent facility of the area. In fact, in the area, no matter if it is a business centre, an hospital, a campus or any other kind of specific area, the services provided by the transport mean could constitute an added value and, for that reason, it has to be managed in a very affective way, mainly as regards safety and reliability for the user and, also, as regards the managing costs for the centre where it is provided.

### SUMMARY OF THE INVENTION

Object of the present invention is to propose a transport mean for partially disabled people with great reliability, versatility and safeness of use, and that, moreover, is a valid option with respect to motorized wheel-chairs.

Further specific object of the present invention is to propose a transport mean for partially disabled people which allow autonomously accessing business centres in a safe and simple manner.

Another object of the present invention is to propose a method to manage the above transport means to allow their reliable and safe utilization.

Another object of the present invention is to propose a method to manage the above transport means particularly suitable to let use said transport means in specific areas such as business centres, or other shopping centres, hospitals, campus, libraries, courts of justice are other large public areas.

The aforesaid objects are attained through a self moving transport mean for partially disabled people comprising a flat surface supporting a wheel-chair for partially disabled people or a seat, at least one electric traction engine, a plurality of wheels touching the ground, at least one steering mechanism and a drive interface.

Advantageously, a board is pivotably bound to one side of the flat surface, said board being able to rotate from a first position in which the side opposite to the hinged one is in contact with the ground, to facilitate the wheel-chair to get on the flat surface, to a second position substantially vertical, apt to restrain the wheel-chair onboard the transport mean.

The transport mean further comprise means for lifting said flat surface with respect to the level of the wheels and a chassis to which said wheels are connected, said lifting means acting between said chassis and said flat surface.

In a preferred embodiment of the invention the chassis and the other components firmly connected to it, such as the lifting means which in this case comprise a worm screw-nut coupling, are shaped and housed so that they do not enter the space defined by the plan overall dimensions of said flat surface, allowing the flat surface to be lowered until it reaches or is close to the ground.

Alternatively, said lifting means provide a scissor mechanism, moved by an electric actuator or by a hydraulic cylinder.

In addiction, the front and lateral zones of the transport mean are provided with a carter and/or with bumpers apt to restrain the wheel-chair, to protect it from possible hits, and also for housing at least one shopping basket.

The vertical axle of the steered wheels can be advantageously rotated, through the steering mechanism, of an angle of about 180°. In a very advantageous embodiment as regards the motor and the steering mechanism, there are four wheels, and one of the fore wheels and the rear wheel on the opposite side are driving and steered wheels, whereas the other two wheels are freely rotating and freely pivotable around their vertical axis.

In a different embodiment all the wheels are freely pivotable, the steering mechanism acting on a further central wheel, or roller, which can be steered at 360°.

The drive interface comprise, advantageously, a joystick operating said at least one traction motor and said at least one steering mechanism, as well as buttons or leverages apt to operate of said lifting means.

The electric traction motor is fed by rechargeable batteries placed onboard the transport mean, a box for housing said transport mean being also apt to recharge said batteries.

Moreover, safety devices are provided comprising:
means for locking the wheel-chair onboard the flat surface;
means for enabling the powering of said at least one traction motor enabled as a function of the position of the rear board, the position of the wheel-chair with respect to the flat surface and of the position of the lifting means;
means for enabling putting into motion of the lifting means enabled as a function of the working status of roll preventing means of the transport mean and of motor and steering means powered off;
obstacle detecting means.

The transport mean finally comprise, advantageously, a processing unit combined with input and/or display means which, through a proper software, provide information collected from a positioning system installed onboard and other information about the centre, useful to the user.

The above objects are also obtained through a method for managing transport means for partially disabled people in specific areas comprising phases of:
access of a user to a specific area comprising at least one housing box of a transport mean, and transfer to said housing box;
getting of the user onboard the transport mean;
enabling said transport mean;
driving said transport mean towards desired destinations inside said specific area;
driving said transport mean back to the housing box;
parking said transport mean inside said housing box and disabling it;
getting of the user off the transport mean;
resting of said transport mean in said housing box until its next use, said housing box being also apt to recharge of feeding means of said transport mean.

Advantageously, said phase of enabling said transport mean comprises phases of:
entering, through said interface means of the transport mean, personal data of the user, said data comprising data apt to check that the user is allowed to use said transport mean;
performing a diagnostic procedure about said transport mean which is enabled or not as a result of said diagnostic procedure;
binding said wheel-chair in said transport mean;
releasing said transport mean from said housing box;
enabling the drive system of said transport means.

Alternatively, said phase of entering user's data occurs, through interface means placed on the housing box, before the access of the user onboard the transport mean, the access being enabled upon proper identification of the user.

Advantageously, said parking and disabling phase of the transport mean, comprises phases of:
access of said transport mean into said housing box;
binding said transport mean to the housing box and disabling the drive system;
releasing said wheel-chair from said transport mean;
powering the recharge of the batteries of said transport mean;
   the managing method may also comprise phases of exchange of data between said transport mean and said housing box and/or between these ones and a central processing and storing unit of the business centre providing said transport mean, said data comprising:
information about products and services of the centre, which can be displayed by display means of said transport mean;
diagnostic information about the components of said transport mean;
statistical data concerning the use of said transport mean.

According to what above disclosed are clear the advantages concerning the use of a transport mean for partially disabled people according to the invention, that allow completely enjoying buildings and areas often inaccessible and that make they able to be self-sufficient in said areas. Further relevant advantages relate its functionality and safety.

It is also evident that with the management method of the invention every area providing such transport means can offer to partially disabled people, even to people moving on wheel-chairs a set of functions and services that they could not otherwise access, assuring at the same time a high level of safety and reliability.

The extreme practicality and easiness of the method moreover assure low costs and a complete control of the transport means.

### BRIEF DESCRIPTION OF THE DRAWINGS

Anyway, for a better understanding of the characteristics and the advantages of the present invention, they will now be described, by way of examples, embodiments of the invention itself, with reference to the accompanying drawings, in which:

FIG. 1 shows a side view of a transport mean according to the invention;

FIG. 2 shows a top view of the transport mean of FIG. 1;

FIG. 3 shows a front view of the transport mean of FIG. 1;

FIG. 4 shows a section view, made along the section plane IV-IV of FIG. 3, of the transport mean of FIG. 1;

FIG. 5 shows a side view of the transport mean of FIG. 1 in a different operating configuration;

FIG. 6 shows a schematic top view, of a specific device of the transport mean of FIG. 1;

FIG. 7 shows a perspective view of a different embodiment of a transport mean according to the invention;

FIG. 8 shows a perspective view of specific parts of the transport mean of FIG. 7;

FIG. 9 shows an operating flow chart of a management method according to the invention;

FIG. 10 shows an operating flow chart concerning one phase of the flow chart of FIG. 9;

FIG. 11 shows an operating flow chart concerning one more phase of the flow chart of FIG. 9;

FIG. 12 schematically shows a business centre where a transport mean is used according to the method of the invention.

### DESCRIPTION OF PREFERRED EMBODIMENTS

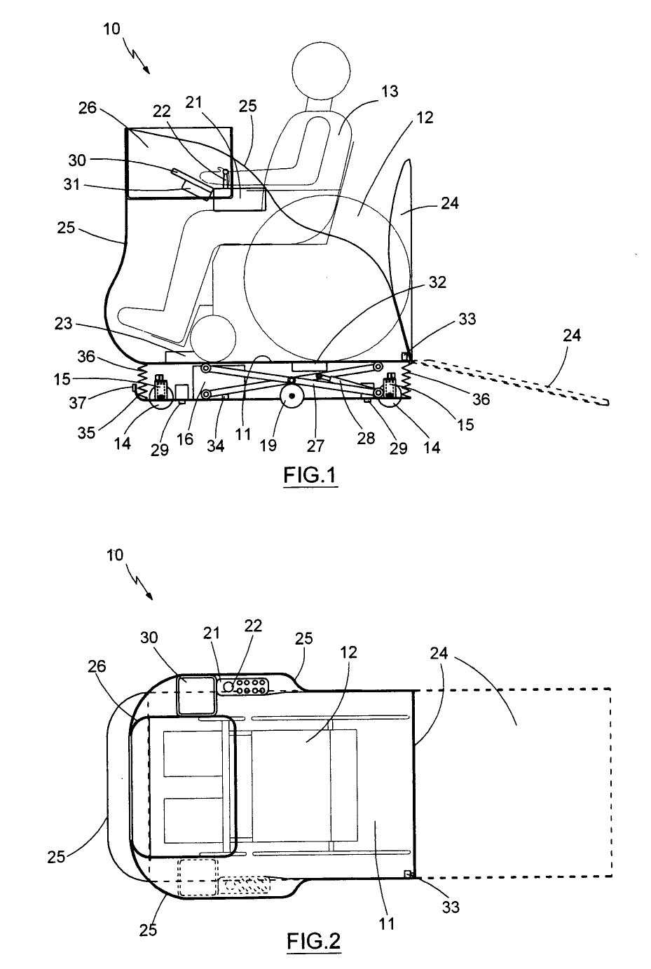

With reference to FIG. 1 to 4, it is shown as a whole with 10 a self moving transport comprising a flat surface, 11, supporting a wheel-chair, 12, and its user, 13, wheels, 14, of the transport mean 10 touching the ground, electric traction motors, 15, moving said wheels and fed by rechargeable batteries, 16.

In FIG. 4, are displayed steering means, 18, of known technique, that control the rotation of vertical steered axles of the four fore and rear wheels 14. Alternatively, said axles may be freely rotating and the steering effect is obtained through a central motorized roller, 19, steered of 360° by a circular crown, 20.

The traction motors 15 and the steering means 18 and/or 20, are controlled through a drive interface, 21, placed at the right side of the transport means at level that it can be easily controlled by the user 13. Said drive interface comprises a joystick, 22, which allow an easy setting of the direction of the transport mean, as well as a set of buttons and levers for commanding the various functions of the transport mean.

On the flat surface, 11, are mounted resting means, 23, for blocking the fore wheels of the wheel-chair 12, and a board, 24, is hinged to the rear side of the flat surface 11. Said board, as shown in dot line in FIGS. 1 and 2, is able to rotate form a substantially vertical position, where it works as a wheel-chair restraining wall preventing the backwards rotation of its wheels, to a position in which the free end of the board is in contact with the ground, so that it works as slide to facilitate the wheel-chair 12 to get onboard the transport mean 10.

The movement of the board 24 is controlled through buttons of the drive interface 21.

The wheel-chair is laterally restrained onboard the vehicle thanks to a carter, 25, whose perimeter is shown in FIGS. 1, 2, and 3. Said carter, bound to the flat surface 11 extends along three sides of the vehicle and supports the drive interface 21 and a shopping basket, 26.

Lifting means, 27, act between the flat surface 11 and a chassis, 50, supporting the wheels 14 allowing, as shown in the configuration of FIG. 5, to lift up the flat surface and the wheel-chair or, alternatively, the seat on it. Said lifting means are moved by actuators that in the present embodiment are a hydraulic cylinder, 28, controlled by the drive interface 21.

The chassis 50 comprises, laterally, bumpers, 35, and a folding cover, 36, further bound to the bottom side of the flat surface 11, to hide an protect the components of the transport mean comprised between said two surfaces.

Roll preventing means, 29, made of further hydraulic cylinders bound to the chassis 50 or to the flat surface 11 are provided for automatically working when the lifting means 27 are activated to control the horizontal position of the transport mean and prevent possible rolling of it due to fortuitous movements of the wheels 14 or a loss of balance of the load on the flat surface.

Near the drive interface 21 the transport means further provides touchscreen display and/or input means, 30, connected to a processing unit, 31, which gives the user a series of services and useful information, through the use of software and hardware devices of the known art. In fact, said display means 30 are able to provide the user with information concerning products and services of the shopping centre also as regards their position in the area, thanks to a wireless connection to a central database of the centre. Moreover, thanks to a positioning system, for instance a GPS, the best paths to reach a specific destination can be displayed. If the transport mean 10 is used in a business centre through the display means 31 and the processing unit 31, a virtual shopping basket can be created and the products can be marked once the user has picked them up, just as already occur in many shopping centres.

The transport mean 10 is provided in addiction to the safety devices prescribed by the law, also further safety devices apt to assure its reliable and safe use.

The presence of the wheel-chair onboard is checked thanks to load cells, 32, installed on the bottom side of the flat surface 11; the resting means, 23, comprise switches; on the flat surface, close to the board's hinge means is provided one more switch, 33, to control the closed position of the board 24; proximities, 34, are provided to detect that the lifting means are in the lowest position; the traction motors 15 and the steering means 18 and/or 20 are provided with sensors and encoders apt to detect the movement and direction of the transport means; further sensors, 37, integral to the bumpers 35 along the perimeter of the transport means allow detecting obstacles so that the run of the vehicle can by immediately stopped or its speed reduced.

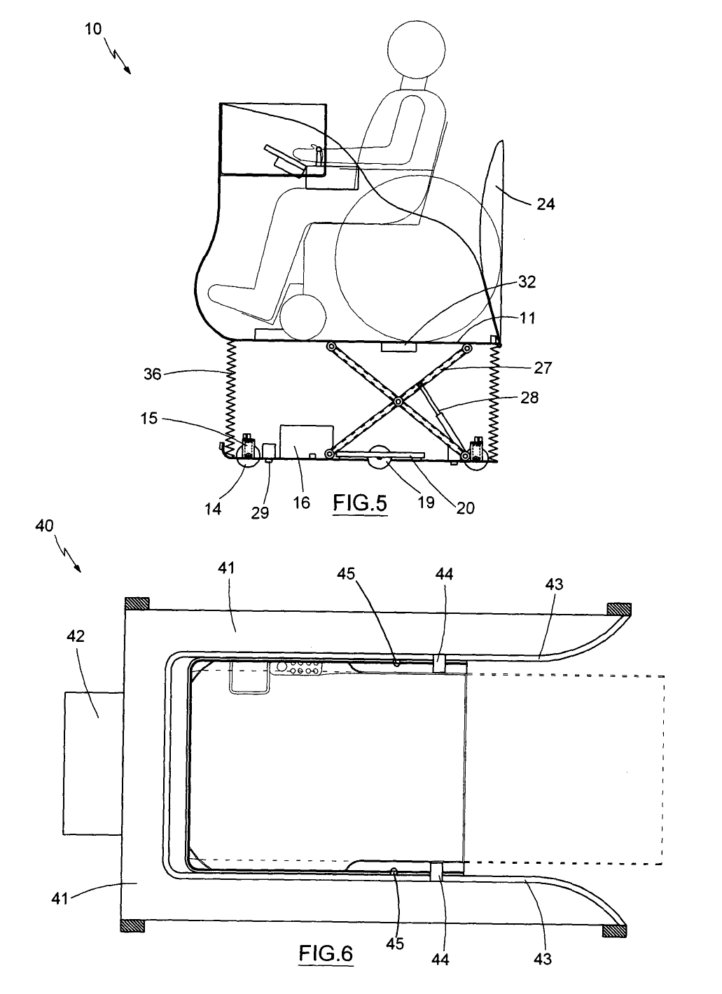

To complete the transport mean 10 as a supplementary facility, a housing box, 40, is provided, shown in FIG. 6, comprising a frame, 41, recharging means, 42, of the batteries, 16, of the vehicle, bumper bars, 43, and resting means, 44, for blocking the vehicle.

Sensors, 45, apt to check the presence of the vehicle in the box are also provided to enable the recharge of the batteries.

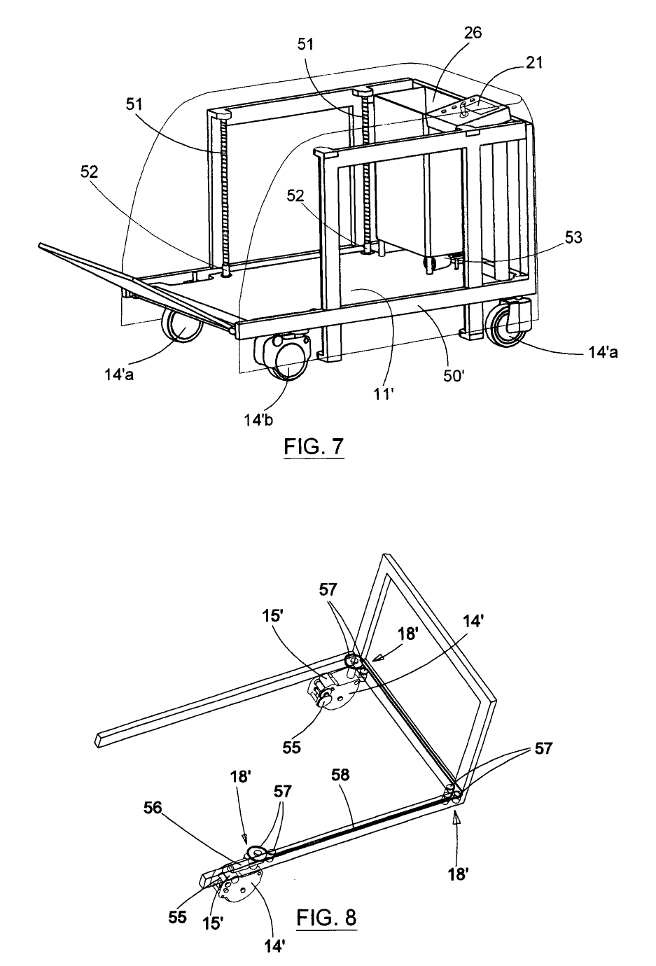

A particularly advantageous embodiment of the invention is schematically shown in FIGS. 7 and 8.

In that embodiment of the transport mean 10′, the chassis, 50′, supporting the wheels, 14′a and 14′b, comprises worm screws, 51, with vertical axle, along which move a nuts, 52, integral to the flat surface, 11′.

An electric actuator, 53, put into rotation, through proper gear means, said worm screws 51 and then the vertical movement of the flat surface 11′. In the present embodiment the space underneath the flat surface 11′ is free of parts of the vehicle, for instance the wheels 14′a and 14′b, the lifting means or any supporting structure, so that, by providing a proper length and placement of the worm screws 51 the flat surface can be lowered until it reach or get close to the ground, so further facilitating the access of the wheel-chair onboard the vehicle, in case even without the board 24.

In FIG. 8 are schematically shown the advantageous solutions adopted for drive and steering mechanisms.

In fact, traction motors, 15′, are directly connected, through proper gear motors, 55, to one of the fore wheels 14′b and the opposite rear wheel 14′b.

To this two wheels 14′b are also connected the steering means, 18′, whilst the two more wheels, 14′a, one fore wheel and the opposite rear wheel, are freely rotating around their axle and around a vertical axle.

In particular the steering means 18′ are made of a gear motor, 56, directly connected to the steered vertical axle which connect the wheel to the chassis 50, and of a series of gear wheels, 57, through which passes a chain, 58, for transmitting the movement to the axle connecting the other steered wheel to the chassis.

This last driving and steering system allow the transport mean 10′ to perform both translation movements in any direction and steering movements, performed thanks to the fact that the speed of the two drive wheels is independently set.

The way of functioning and the way of use of the self moving transport mean for partially disabled people according to the invention are easily understandable from what above disclosed.

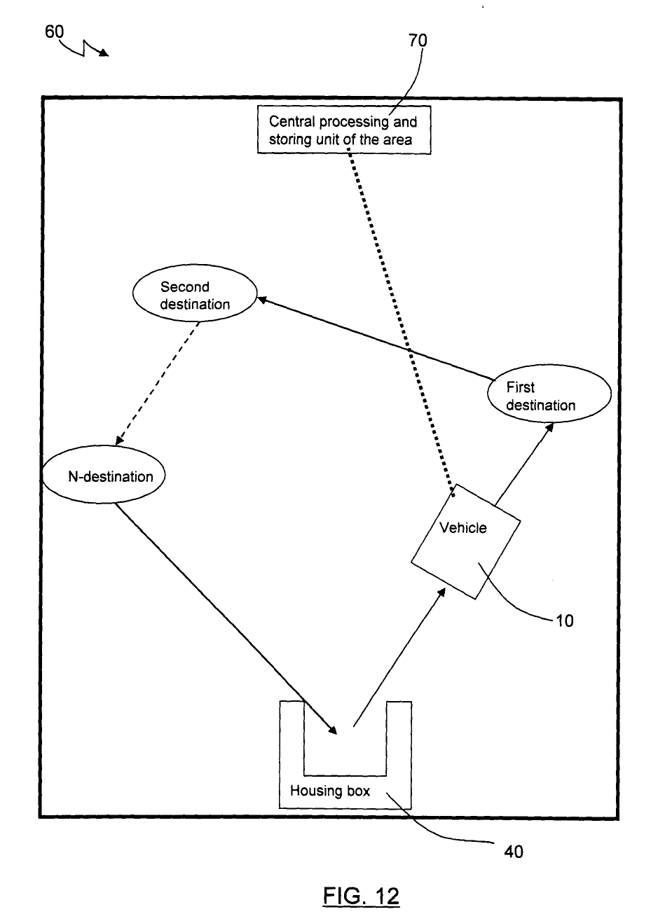

In a specific area, 60, whose limits are schematically shown in FIG. 12, is placed a housing box, 40, of transport mean 10 for partially disabled people.

Said box 40 is advantageously placed in a central position inside the area, or in a specific park area, or, anyway, in any part of the area easily accessible by the user.

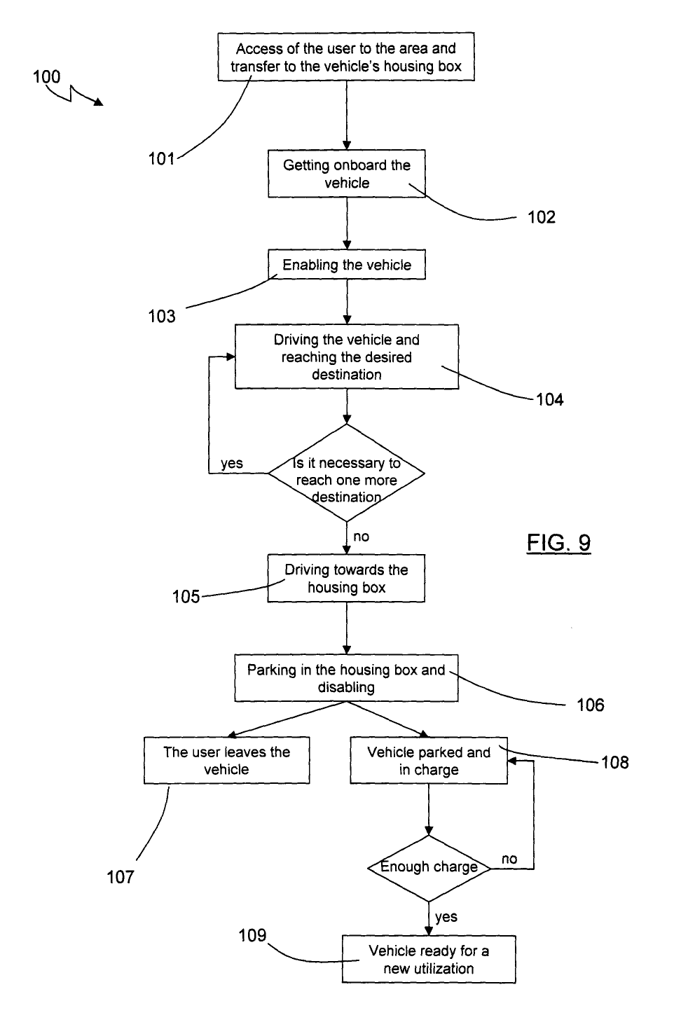

The user who wants to access the services of the area 60 performs the management method 100, shown in FIG. 9.

Exactly, according to what provided for in phase 101, once reached the area 60, the user move in correspondence to the housing box, 40.

Here is, properly parked, the vehicle 10 having its board 24 lowered, and according to phase 102, the user autonomously gets on the vehicle.

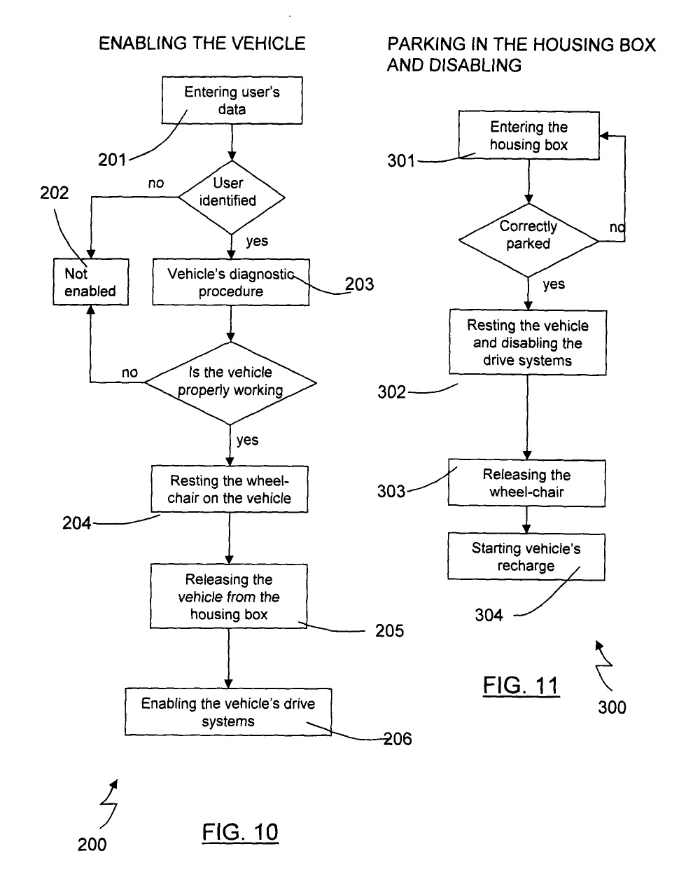

Then, according to phase 103, the user starts enabling the transport mean 10. To this aim is performed, in particular, the procedure shown in FIG. 10. First thing the user insert his personal data, phase 201, apt to allow the vehicle identify him as authorized user. That phase, 201, can be performed through a magnetic card owned by the user and a card reader on the vehicle 10, or through a bar code and its reader, either trough manual input of an identification code through input means of the vehicle, or through different means.

If the user is not identified the vehicle generates an error message and it is not enabled, phase 202. Otherwise, if the user is identified an automatic diagnostic procedure occurs, phase 203, apt to check if the vehicle can be safely used. If the diagnostic procedure gives a negative response the method step back to phase 202, that is the transport mean is not enabled. Otherwise, in case the vehicle properly works, and it is designed to house a wheel-chair, resting means 23 of the fore wheel of the wheel-chair are operated, according to phase 204, in order to prevent fortuitous movements of the wheel-chair, and also the board 24 is lifted in vertical position. After that, phase 205, the vehicle is released from the housing box 40 by disengaging, after permission given by the sensors 32, its resting means. The enabling procedure, 103, ends with the enabling of the drive interface 21 of the transport mean, phase 205.

Then, after permission of the switch 33, of the sensors of the resting means 23 and of the proximities 34 detecting the position of the lifting means 27, the user 13, moving the joystick 22, is able to drive the vehicle off the housing box and towards the desired destination, phase 104. In any moment the user can use the display and/or input means 30 to get useful information.

When it is used inside shopping centres, the user is able to see a list of available products, create a virtual shopping basket and check the position and the path to the reach the products.

During its run towards its destination the user is continuously attended with information read or listened from the display and/or input means 30, and he is also attended by the sensors 37 that slow down or stop the vehicle when it get close to possible obstacles.

Once reached the destination, for instance the zone of a supermarket's shelf where there is the desired product, the user, through the drive interface 21 rotates of an angle of 90° the wheels 14 of the vehicle, or the central roller 19, to enable a lateral approach to the shelf Then, the product is picked and put in the basket 26.

Alternatively, in case the product is placed to high and the user cannot reach it, the user activated the lifting means 27.

It has to be noticed that, according to a specific embodiment, the lifting means works only of sensors associated to the traction motor detects that the vehicle is unmoving, the sensors 33 state that the board is in vertical position and the roll preventing means 29 are working. Furthermore, until the lifting means 27 are not back in the running configuration, the traction motors 15 and 15′, the steering means 18, 18′ or 20′ and the board 24 are deactivated.

Once the lifting means have been lowered and the roll preventing means have been lifted, it is possible to drive the vehicle and reach a new destination or come back to the box 40.

When the user completes the operations at the previously reached destination, if he needs to go to a further destination is performed again phase 104, otherwise the user drives the vehicle towards the housing box, phase 105, and, once reached, starts parking and disabling the vehicle, phase 106.

This last phase advantageously occurs according to the procedure shown in FIG. 11.

The transport mean 10 is driven inside the box 40 until it reaches a stop position, phase 301. A signal of park correctly performed enable the disabling of the drive interface 21 and the powering of the resting means 44, phase 302. The correct fulfillment of the parking procedure could also be signaled by the possibility to bind the vehicle to the box. In this case once bound the vehicle's drive interface could be automatically disabled.

Then the wheel-chair is released, 303, to allow the user getting off the vehicle 10.

At the same time, according to phase 304, the recharging means 42 of the batteries 16 start working thanks to a connection of the vehicle to the housing box.

The user get off the vehicle, phase 107, and it rests parked inside the box in recharging mode, phase 108.

A sensor of the charge level of the transport mean allow defining if it can be used once again. In this case even if the vehicle in in-charge it is also ready for a new use, phase 109. Otherwise, if the charge level is not enough the vehicle have to stand-by in the housing box according to phase 108.

Obviously many modifications and changes could be carried out, both to the transport mean and to the management method, still keeping safe their advantages and features.

A simple modification may consist of providing the flat surface 11 with a seat, in case pivotable around a vertical axle to let the user take place on it more easily. In this case the seat replaces the wheel-chair and transport mean is specifically intended for elder people that, even if they have limited moving capacity are not necessarily obliged to move on wheel-chairs.

Further modifications may concern the components of known technique of the vehicle which may vary and be replaced with components having the same function.

In particular, the lifting means 27 of the flat surface 11 could be, for instance, parallelogram type lifters, or simple pneumatic or hydraulic cylinders directly acting between the chassis supporting the wheels 14 and the flat surface 11. The electric traction motors 15 and the steering means 18, 18′ and/or 20 may vary both as regards their number and their type.

The load cells, 32, the switches 33 and the other sensors and safety means above described may be of a different standard type, or of innovative conception, remaining anyway unchanged their function.

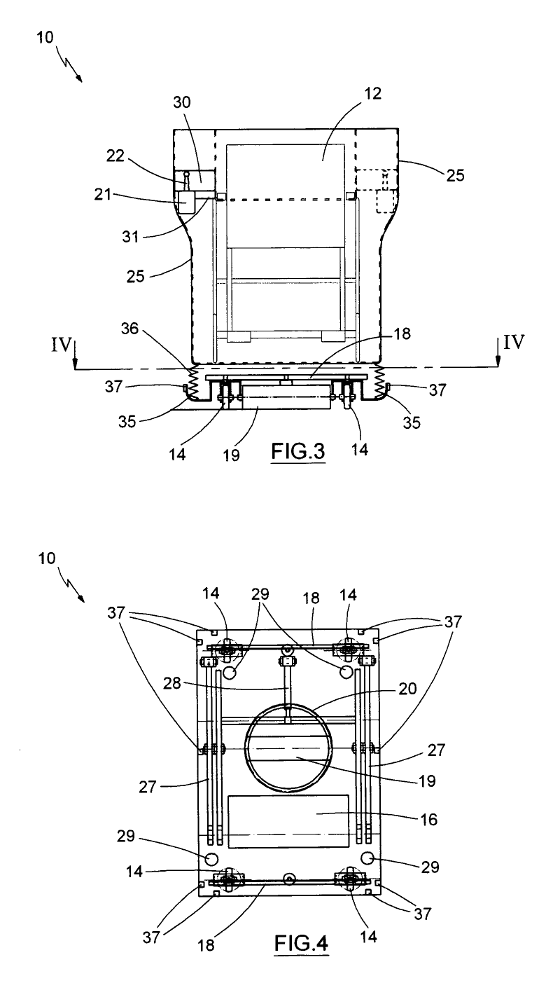

The drive interface 21 and the display and/or input means 30 could be placed, as shown in FIGS. 2 and 3, at the left side of the vehicle, in order to allow the use of it also to left handed people or people who have an inadequate mobility of the right arm.

Said display and/or input means 30 and the processing unit 31 could even be not provided in cheaper versions of the vehicle, as well as could widely vary the kind of software in it and the information provided, mainly as a function of the kind of areas where the vehicle is used. So, in case the vehicle is used in shopping centres is relevant the presence of the shopping basket 26 and of a list of the available products and their position, obtained through a wireless connection, shown in FIG. 12, between the vehicle 10 and a central processing and storing unit 70. Alternatively, when the transport mean is located in a campus or in a hospital is more important the availability of a positioning system, such as a GPS or similar. What's more, in these last kind of areas, could be not useful the lifting means, not providing them resulting in a cheaper vehicle.

A connection to a central processing and storing unit 70 could be advantageous in any case to have stored in it diagnostic reports about the transport mean 10 and statistical data about its use, which can be used to optimize the management of the vehicle.

The flat surface 11 may be differently shaped with respect to the substantially rectangular shape above described, and the carter shown through its perimeter 25, could be designed to have a good aesthetic impact, or it could even be totally or partially removed, the support of the drive interface 21 and of the basket 26 being carried out by different structural parts bound to the flat surface 11.

As regards the method for managing the vehicle the procedures concerning the enabling of the transport mean, phase 103, and its disabling, phase 106, could be substantially changed and simplified with respect to the ones described.

The guidance of the transport mean, phase 104, could be completely automated, by the use of standard automatic guide means such us the AGV's guiding means, by using a positioning system, or even using automatic guide techniques of new conception.

Phase 201 of identifying the user could be carried out before the access of the user onboard the vehicle, phase 102. In fact, the input means for inserting the user's personal data could be placed on the housing box 40, the access to the vehicle being allowed only after identification of the user.

These and more changes or modifications can be brought to the self moving transport mean for partially disabled people according to the invention and to the relating method for managing it in specific areas, still remaining in the ambit of protection defined by the following claims.

1-47. (canceled)

48. Self moving transport mean for partially disabled people comprising:
at least one flat surface supporting at least one wheelchair or a seat,
at least one electric traction motor,
a plurality of wheels touching the ground,
a steering system,
a drive interface,
lifting means (27) for lifting said flat surface (11) supporting said wheel-chair (12) or seat with respect to the ground characterized in that it comprises a chassis to which are bound said wheels (14), said lifting means (27) resting between said chassis and said flat surface (11).

49. Transport mean (10) according to claim 48 characterized in that said chassis and other components firmly connected to said chassis are shaped and housed so that they do not enter the space defined by the plan overall dimensions of said flat surface, allowing the flat surface to be lowered until it reaches or is close to the ground.

50. Transport mean (10) according to claim 48 characterized in that said lifting means (27) comprise worm screws integral to the chassis coupled to nuts integral to said flat surface.

51. Transport mean (10) according to claim 48 characterized in that said wheels (14′a, 14′b) are four in number, placed in correspondence to the corners of said transport mean, one of the two front wheels (14′b) and the rear wheel at the opposite side (14′b) being driving and steered wheels, the other two wheels (14′a) being freely rotating around their axle and freely pivotable around a vertical axle.

52. Transport mean (10) according to claim 48 characterized in that said at least one traction motor and said steering system are apt to allow the transport mean to move ahead, to steer, and to translate laterally and/or in inclined directions.

53. Transport mean (10) according to claim 48 characterized in that said flat surface (11) supports a seat firmly bound to it.

54. Transport mean (10) according to claim 48 characterized in that said seat is pivotable with respect to a vertical substantially barycentric axle.

55. Transport mean (10) according to claim 48 further comprising a box (40) for housing said transport mean (10), said box (40) comprising means for recharging (42) of said rechargeable batteries (16).

56. Transport mean (10) according to claim 48 comprising means for enabling the powering of said traction motor (15) which are activated in function of the position of the board (24), of the position of the wheel-chair (12) with respect to said flat surface (11) and in function of the level of said flat surface (11) with respect to the ground.

57. Transport mean (10) according to claim 48 comprising means for enabling putting into motion the actuators (28) of the lifting means (27) enabled as a function of the position of the board (24) and of the condition of traction motor (15) and steering system (18, 20) unmoving.

58. Transport mean (10) according to claim 48 further comprising means for detecting obstacles (37).

59. Transport mean (10) according to claim 48 further comprising a processing unit (31) combined with display and/or input system (30), which, through specific software, display information useful to the user.

60. Transport mean (10) according to claim 59 characterized in that said processing unit (31) communicates, periodically or in continuous, with a central processing unit of the area where is the transport mean, the information displayed by said display and/or input system (30) coming from databases of said central processing unit.

61. Transport mean (10) according to claim 59 further comprising a positioning system that determines location of said transport mean.

62. Transport mean (10) according to claim 61 characterized in that said display and/or input system (30) displays information coming from said positioning system.

63. Method for managing a transport mean for partially disabled people in specific areas such as business centres, shopping centres or the like, characterized in that said method comprises phases of:
access of a user to a specific area comprising at least one housing box of a transport mean for partially disabled people, and transfer to said housing box;
getting of the user onboard said transport mean;
enabling said transport mean;
driving said transport mean towards desired destinations inside said specific area;
driving said transport mean back to said housing box;
parking said transport mean inside said housing box and disabling it;
getting of the user off the transport mean; and
resting of said transport mean in said housing box until its next use, said housing box being also apt to recharge batteries of said transport mean.

64. Method for managing a transport mean according to claim 63 characterized in that said user (13) is a user on a wheel-chair (12), the access onboard said transport mean taking place directly with said wheel-chair.

65. Method according to claim 63 characterized in that in said housing box (40) takes place the recharge of the batteries (16) of said transport mean (10).

66. Method according to claim 63 characterized in that said enabling phase (103) of said transport mean (10) comprises a phase (201) of entering user's data, said data comprising data apt to check that the user is allowed to use said transport mean.

67. Method according to claim 63 characterized in that said phase (201) of entering user's data takes place through interface means located on said housing box (40).

68. Method according to claim 63 characterized in that said enabling phase (103) comprises a phase (203) of performing a diagnostic procedure about said transport mean (10), said transport mean being enabled or not as a result of said diagnostic procedure.

69. Method according to claim 63 characterized in that said enabling phase (103) comprises a phase (204) of binding said wheel-chair (12) in said transport mean (10).

70. Method according to claim 63 characterized in that said enabling phase (103) comprises a phase (205) of releasing said transport mean (10) from said housing box (40).

71. Method according to claim 63 characterized in that said enabling phase (103) comprises a phase (206) of enabling (206) the drive system of said transport mean (10).

72. Method according to claim 63 characterized in that said parking and disabling phase (106) comprises a phase (302) of binding said transport mean (10) to said housing box (40) and disabling said drive system.

73. Method according to claim 63 characterized in that said parking and disabling phase (106) comprises a phase (303) of releasing said wheel-chair (12) from said transport mean (10).

74. Method according to claim 63 characterized in that said parking and disabling phase (106) comprises a phase (304) of powering the recharge of the batteries of said transport mean (10).

75. Method according to claim 63 characterized in that it comprises one or more phases of data exchange between said transport mean (10) and at least one central processing and storing unit (70).

76. Method according to claim 63 characterized in that said data exchange comprises at least one phase of exchange of data between said central unit (70) and said housing box (40) and at least one phase of exchange of data between said housing box (40) and said transport mean (10).

77. Method according to claim 63 characterized in that said data exchanged during said one or more data exchange phases comprise information concerning products and services of the specific area (60), which can be read or listened thanks to said display and/or input means (30) of said transport mean (10).

78. Method according to claim 63 characterized in that said data exchanged during said one or more data exchange phases comprise diagnostic data of said transport mean (10).

79. Method according to claim 63 characterized in that said data exchanged during said one or more data exchange phases comprise statistical data concerning the use of said transport mean (10).

80. Method according to claim 63 characterized in that said driving phase (104) comprises phases of displaying on said display means (30) a list of available products or services of the area (60), checking their position and/or the path to reach said products or services.

81. Method according to claim 63 characterized in that said driving phase (104) comprises, after having reached the desired destination, a phase of approaching said destination by a lateral approach.

82. Method according to claim 63 characterized in that said lateral approach is obtained by rotating of an angle of about 90° the wheels (14) of the vehicle.

83. Method according to claim 63 characterized in that said driving phase (104) comprises, after having reached the desired destination, a phase of activating said lifting means (27).
